(19) United States
(12) Patent Application Publication
(10) Pub. No.: US 2020/0066004 A1
(43) Pub. Date: Feb. 27, 2020

(54) TEXT FOCUS FOR HEAD MOUNTED DISPLAYS

(71) Applicant: International Business Machines Corporation, Armonk, NY (US)

(72) Inventors: Joshua E. Vines, Telford (GB); Amy Madelaine Reeve, Southampton (GB); Liam White, Hampshire (GB); Tom Waterton, Southampton (GB)

(21) Appl. No.: 16/109,967

(22) Filed: Aug. 23, 2018

(51) Int. Cl. G06T 11/00; G06K 9/62; G06F 3/01; G06K 9/32; G06T 11/60

(52) U.S. Cl. CPC G06T 11/001; G06K 9/6201; G06F 3/167; G06K 9/3258; G06T 11/60; G06F 3/013

(57) ABSTRACT

Aspects of the present disclosure relate to improved text focus for head mounted displays (HMDs). Sensor data is received from an eye-tracker of an HMD equipped by a user. A determination whether the user is reading is made. In response to determining that the user is reading, a text area on a display of the HMD is determined. The display of the HMD is then filtered based on the determined text area, where a non-text area of the display is filtered and the text area is not filtered.

### BACKGROUND

The present disclosure relates generally to the field of head mounted displays, and in particular to improved text focus for head mounted display devices.

Head mounted displays (HMDs) are display devices which present images over users' fields of view. The images can overlay the physical world to provide enhanced perceptual information. These types of HMDs are referred to as augmented reality (AR) devices. The augmentations can be constructive (e.g., adding to the physical world) or destructive (e.g., masking the physical world). In contrast, virtual reality (VR) HMDs attempt to completely replace reality with a virtual representation. HMDs can provide visual, auditory, haptic, somatosensory, olfactory, etc. sensations to users.

### SUMMARY

Embodiments of the present disclosure relate to a system, method, and computer program product for improved text focus for head mounted displays (HMDs). Sensor data can be received from an eye-tracker of an HMD equipped by a user. A determination whether the user is reading can be made. In response to determining that the user is reading, a text area on a display of the HMD can be determined. The display of the HMD can then be filtered based on the determined text area, where a non-text area of the display is filtered and the text area is not filtered.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 is a block diagram illustrating an example head mounted display (HMD), in accordance with embodiments of the present disclosure.

FIG. 2 is a flow diagram illustrating an example method for improving text focus on an HMD, in accordance with embodiments of the present disclosure.

FIG. 3 is a flow diagram illustrating another example method for improving text focus on an HMD, in accordance with embodiments of the present disclosure.

FIG. 4 is a diagram illustrating a cloud computing environment, in accordance with embodiments of the present disclosure.

FIG. 5 is a block diagram illustrating abstraction model layers, in accordance with embodiments of the present disclosure.

FIG. 6 is a high-level block diagram illustrating an example computer system that can be used in implementing one or more of the methods, tools, and modules, and any related functions, described herein, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of head mounted displays, and in particular to improved text focus for head mounted displays. While the present disclosure is not necessarily limited to such applications, various aspects of the disclosure can be appreciated through a discussion of various examples using this context.

When reading, individuals can become easily distracted by movements/objects in their peripheral vision. Such distractions can cause readers to lose focus, which slows their reading progress and reduces their engagement with the text. This is true in the physical world as it is in the augmented reality (AR) and virtual reality (VR) realms. AR and VR technologies provide sensory data to users to enhance and/or replace the physical world with virtual objects/artifacts. When a user wearing a head mounted display (HMD) is reading, the user can become distracted if physical and/or virtual objects are moving in the background. Accordingly, aspects of the present disclosure are directed to improving text focus while a user is wearing an HMD.

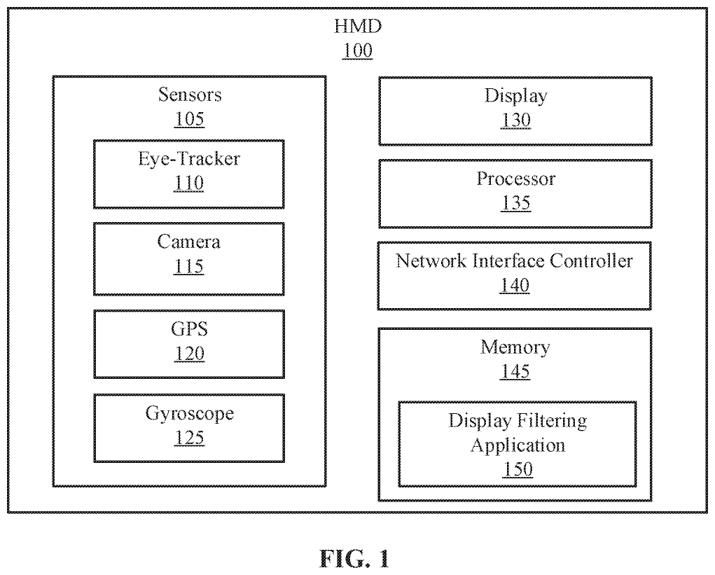

Referring now to the figures, FIG. 1 is a block diagram illustrating an example head mounted display (HMD) 100, in accordance with embodiments of the present disclosure. The HMD 100 can include various components. As depicted in FIG. 1, the HMD includes sensors 105, a display 130, a processor 135, a network interface controller (NIC) 140, and a memory 145. Though various components of the HMD 100 are shown in FIG. 1, additional components not depicted in FIG. 1 can also be present without departing from the spirit and scope of the present disclosure.

The HMD 100 can be embodied in a variety of devices. For example, the HMD 100 can be embodied in eye glasses (e.g., monocular or binocular), contact lenses, a head set, a heads-up display (HUD), a virtual retinal display (VRD), a monitor, or a handheld device. Further, the HMD 100 can have AR or VR capabilities. That is, the HMD 100 can be configured to provide enhanced sensory information to a user which can either overlay the physical world (as in AR) or replace the physical world with a virtual representation (as in VR).

The display 130 of the HMD 100 can be configured to provide visuals to users. In embodiments, the display 130 can include a screen (e.g., a semi-transparent or transparent screen) having a plurality of pixels for displaying visual data. The display 130 can include a liquid crystal display (LCD), cathode ray tubes (CRTs), light emitting diodes (LEDs), organic light emitting diodes (OLEDs), etc. The screen resolution, pixel density, pixel bit depth, sampling pattern (e.g., a 2-D grid of pixels), etc. can vary, and can depend on the selected display technology and/or the processing capabilities of the HMD 100.

The HMD 100 can include a plurality of sensors 105 configured to collect surrounding conditions which can be used to dictate activation of settings and/or issuance of actions by the HMD 100. As depicted in FIG. 1, the sensors 105 include an eye-tracker 110, a camera 115, a global positioning system (GPS) 120, and a gyroscope 125. However, a range of additional sensors can be included on the HMD 100. For example, sensors 105 can include accelerometers, pressure sensors, compasses, temperature sensors, position sensors, radio/magnetic/electric sensors, microphones (e.g., configured to receive voice commands), and inertial sensors, to name a few.

The HMD 100 can be configured to communicate over a network (not shown) via the NIC 140. In embodiments, the HMD 100 can be configured to communicate with any suitable number and/or type of devices over a network. For example, the HMD 100 can communicate with mobile devices (e.g., a smart phone or tablet), servers, vehicles, laptop computers, wearables (e.g., a smart watch), etc. The network can be implemented using any suitable communications media (e.g., a wide area network (WAN), a local area network (LAN), hardwired connections, a wireless link or router, an intranet, etc.). Further, the HMD 100 can communicate using a combination of one or more networks and/or one or more local connections. For example, the HMD 100 can be hard wired to a first device (e.g., a laptop computer), while communicating wirelessly with a second device (e.g., a server).

The memory 145 of the HMD 100 includes a display filtering application 150. The display filtering application 150 can be configured to filter the display 130, based on data obtained by the sensors 105, to reduce distractions while a user wearing the HMD 100 is reading text. A user can easily become distracted by objects and/or motions in their peripheral vision while reading text. Accordingly, the display filtering application 150 can be configured to determine whether a user is reading, determine a text area on the display (e.g., a portion of a display which includes text a user is reading), and filter the display 130 (e.g., activate a non-distracted reading mode) based on the determined text area.

To initiate filtering, the display filtering application 150 can first determine whether a user wearing the HMD 100 is reading. In some embodiments, determining whether a user is reading is completed based on data obtained from the eye-tracker 110. The eye-tracker 110 can be configured to analyze a user's eye movements—e.g., by comparing the position of eye features (e.g., the pupil) with respect to a frame of reference (e.g., a reflection of light off the eye)—and determine whether the movements are indicative of a reading state. Patterns typically observed during a reading state can include, but are not limited to, short, rapid movements (e.g., saccades) intermingled with short stops (e.g., fixations) over a predetermined time period.

After a determination is made that a user is reading, a text area on the display can be determined. The text area can be a portion of text that the user is reading through the display. Accordingly, the text area is defined as a partition of the display screen (e.g., a subset of pixels) which the user is viewing text through. The selected portion of text can be any suitable size (e.g., a line of text, a paragraph of text, a page of text, etc.). The text can originate from any suitable source. For example, aspects of the present disclosure can be configured to improve reading focus for text originating from (i) the physical world, such as on a printed medium (e.g., a book, a newspaper, a billboard), (ii) an electronic screen (e.g., a smartphone, laptop, tablet, monitor, etc.), or (iii) the VR or AR screen (e.g., text superimposed onto the AR/VR environment). In some embodiments, the text area can be determined by referencing data captured by the camera 115. For example, the camera 115 can capture visual data pertaining to a user's field of view. The visual data can then be analyzed (e.g., using image recognition) to determine the text area. In embodiments, the identified text area can be mapped to a subset of pixels on the display (e.g., screen) of the HMD such that the non-text area can be filtered. In some embodiments, data captured by the eye-tracker 110 can be used in combination with the visual data captured by the camera 115 to determine a subset of text (e.g., a subset of text from the text identified using the camera 115) that the user is currently reading. This can be completed by determining the location the eyes are viewing via the eye-tracker 110. In some embodiments, the text area on the display can be manually set by a user.

The display filtering application 150 can then filter the display 130 of the HMD 100 based on the text area. To improve reading focus, the non-text areas can be filtered to reduce distractions (e.g., objects, movements, etc.) in a user's peripheral vision. In embodiments, filtering can refer to dimming, blacking, blurring, obfuscating, or altering a color (e.g., altering pixel bit values) of the display. After the display 130 is filtered, the user may not be able to detect distractions in their peripheral view. The user can then commence reading without distractions, and upon finishing, the display filtering application 150 can be configured to remove the filter from the display 130.

It is noted that FIG. 1 is intended to depict the representative major components of an exemplary HMD 100. In some embodiments, however, individual components may have greater or lesser complexity than as represented in FIG. 1, components other than or in addition to those shown in FIG. 1 may be present, and the number, type, and configuration of such components may vary. For example, additional sensors (e.g., an accelerator) may be included. In some embodiments, the NIC 140 is not included.

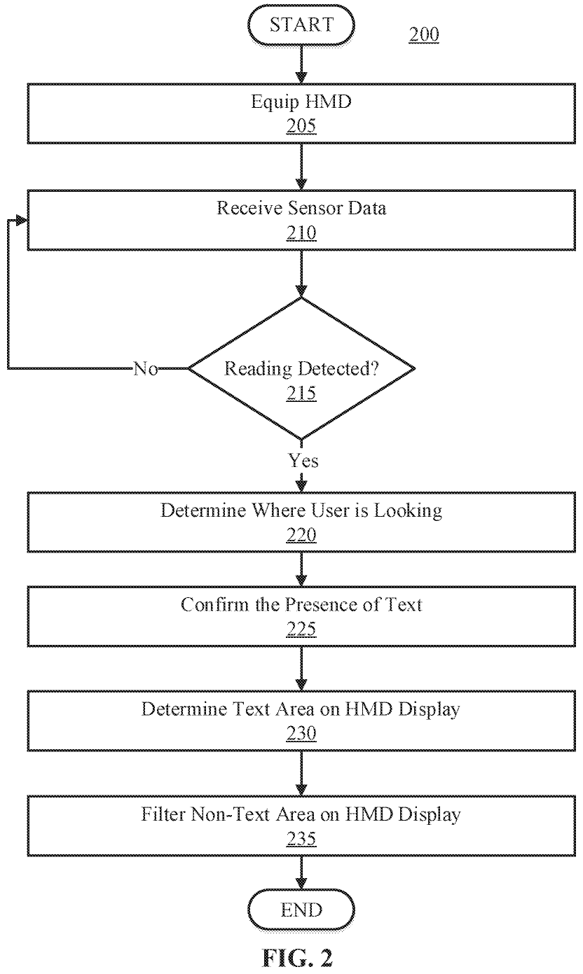

Referring now to FIG. 2, shown is a flow diagram illustrating a method 200 for filtering a display of an HMD to improve text focus, in accordance with embodiments of the present disclosure.

The method 200 can initiate when a head mounted display (HMD) (e.g., HMD 100 of FIG. 1) is equipped (e.g., worn, put on, engaged, activated, etc.) by a user. This is illustrated at operation 205. The HMD can include any features/components described in FIG. 1. For example, the HMD can include a variety of sensors, a NIC, a processor, a memory, etc. In embodiments, the HMD can be embodied in eye glasses, a heads-up display, contact lenses, a head-set, etc. Further, the HMD can have VR or AR capabilities.

After the HMD is equipped and activated (e.g., powered on) by the user, sensor data is received. This is illustrated at operation 210. In embodiments, the sensor data can be obtained from a variety of sensors (e.g., an eye-tracker, camera, gyroscope, etc.). The sensor data can be used to dictate the activation of settings and/or the execution of actions by the HMD. In embodiments, sensor data can be continually received while the HMD is in use.

A determination is made whether the user is reading. This is illustrated at operation 215. Determining whether the user is reading can be completed in a variety of manners. In some embodiments, the determination whether the user is reading is completed based on sensor data obtained by an eye-tracker (e.g., eye-tracker 110 of FIG. 1). The eye-tracker can be configured to measure eye position/movement over time. For example, the eye-tracker can be configured to track eye-movements via eye-attached tracking (e.g., for contact lens HMD devices), optical tracking (e.g., by measuring the light reflected from the eye), and/or electric potential measurements (e.g., by measuring electric potential associated with electrodes placed around the eyes).

In embodiments, a determination whether a user is reading is completed by measuring and analyzing a scanpath of the user. A scanpath is a series of saccades and fixations over time collected by an eye-tracker. Based on patterns indicated in the scanpath collected from a user, a determination whether the user is reading can be completed. For example, fixations typically last 200 milliseconds (ms) when reading text. Accordingly, if the scanpath of the user is analyzed, and the duration of fixations is substantially similar to a particular metric (e.g., 200 ms) indicative of a reading state, then a determination can be made that the user is reading. In some embodiments, the duration of fixations indicated in a scanpath can be averaged over time to obtain an average fixation duration. The average fixation duration can then be compared to a time range (e.g., a lower and upper time threshold) to determine whether the user is reading. If the average fixation duration falls within the time range, a determination can be made that the user is reading (e.g., assuming a time range is defined as 150-250 ms, if a user's average fixation time is 243 ms, then a determination can be made that the user is reading). In contrast, if the average fixation time does not fall within the time range (e.g., falls below or exceeds the time range), then a determination can be made that the user is not reading (e.g., assuming a time range is defined as 150-250 ms, if a user's average fixation time is 400 ms, then a determination can be made that the user is not reading).

Though fixation duration can be used to determine whether a user is reading, any other suitable metric within a scanpath can be analyzed to determine whether a user is reading. For example, saccade duration, the time between saccades, and the time between fixations can all be considered when determining whether a user is reading. Further, any suitable time range/threshold can be implemented to determine whether a user is reading (e.g., a range of 100-300 ms, an upper limit of 300 ms, a lower limit threshold of 150 ms, etc.)

In some embodiments, determining whether a user is reading can include ensuring the user is reading for a minimum time period. For example, determining that the user is reading can include comparing the time the user is reading (e.g., as determined by a scanpath analysis) to a minimum time threshold. If the time the user is reading exceeds the minimum time threshold (e.g., 10 seconds), then a determination can be made that the user is reading. This can prevent activation of the non-distracted reading mode (e.g., filtering the display) when the user only reads for a short period of time (e.g., a traffic sign or advertisement). This can ensure that the user is actually immersed in reading prior to activation of the non-distracted reading mode.

In some embodiments, additional sensor data can be considered when determining whether a user is reading. For example, data obtained from a camera, display, and/or NIC can be referenced to determine whether a user is reading either in conjunction with, or in place of, data obtained from the eye-tracker.

In embodiments, data obtained from a camera can be referenced to determine whether a user is reading (e.g., by using image recognition to determine whether a user is viewing text). In these embodiments, if eye-tracker data indicates that the user is reading (e.g., based on a scanpath analysis), then data from a camera can be referenced to ensure the user is viewing text. In some embodiments, data obtained from the display of the HMD device (e.g., display 130 of FIG. 1) can be referenced to determine whether a user is viewing text displayed on the HMD. In these embodiments, image recognition and/or pixel bit value analysis can be completed to determine whether text is displayed on the display screen of the HMD. For example, pixel bit values which are currently displayed on a screen can be analyzed to determine whether they indicate that text is being displayed (e.g., based on the spacing and/or colors of pixels). In some embodiments, metadata associated with a display can be referenced to determine whether text is being displayed (e.g., by parsing file formats, file names, etc.). In some embodiments, data obtained via a NIC of an HMD can be used to determine whether a user is viewing text. For example, web browser data (or any other relevant data such as file format data, file name data, etc.) associated with a second device (e.g., a laptop a user is reading while wearing an HMD) can be collected to determine whether text is being displayed on the second device.

If a determination is made that the user is not reading, then method 200 returns to operation 210, where additional sensor data is received. If a determination is made that the user is reading, a location where the user is looking (e.g., the orientation of the user's eyes) is determined. This is illustrated at operation 220. In embodiments, determining where the user is looking is determined via the eye-tracker. The eye-tracker can be configured to determine a precise location the user is looking via eye-attached trackers, optical tracking, and/or electric potential tracking. For example, if optical tracking is used, then infrared light which is reflected from the eye can be sensed by a video camera (or other optical sensor) and compared to the center of the pupil to determine a location where the user is looking. This is completed to ensure the text a user is viewing is accurately identified (e.g., out of many other potential text objects in the background).

The presence of text is then confirmed. This is illustrated at operation 225. In some embodiments, the presence of text can be confirmed at operation 215 when determining whether the user is reading (e.g., based on eye-tracker data). The presence of text can be confirmed by referencing data obtained from a camera, display, or NIC (as discussed with reference to operation 215). For example, a front facing camera mounted on the HMD can be configured to capture a user's field of view to identify text (e.g., words) or text artifacts (e.g., books, articles, pages, etc.) in the user's field of view. As an example, assume the front-facing camera mounted on the HMD captures a user viewing a presentation from a projector (e.g., text projected onto a wall or screen) and a surrounding environment. In this example, the presence of the projector/projected boundary (e.g., a text artifact) or words on the projected surface (e.g., text) can be used to confirm the presence of text.

In embodiments, image recognition can be executed to confirm the presence of text. The image recognition can be completed using camera data, display data of the HMD, and/or image data obtained from another device. In embodiments, statistically generated models (e.g., deep learning such as IBM Watson Image Recognition) can be used to determine the presence of text. The models can compare images (e.g., snapshots from cameras or frames of a video) to a library of pre-classified images. In some embodiments, the image recognition model can be a general model, which can be used to recognize objects, actions, scenes, and colors within an image. The model can then output various classifications corresponding to the particular objects, scenes, and colors, within an image including a corresponding match certainty for each identified classification. For example, assume a user is reading a newspaper outside while having a cup of coffee. In this example, if an image of the user's field of view is captured by a camera, the classifications output by the image recognition can include newspaper, cup, coffee, tree, bird, and grass with corresponding match certainties: newspaper 0.95, cup 0.88, coffee 0.77, tree 0.93, bird 0.67, grass 0.99. In this example, the presence of a newspaper can confirm the presence of text.

In some embodiments, confirming the presence of text can include comparing a particular text artifact (e.g., a newspaper, book, an article displayed on a laptop, etc.) to a match certainty threshold output by the statistically generated model. Following the example above, assume a particular text artifact is required to exceed a match certainty threshold of 0.70. If the classification newspaper was indicated to have a match certainty of 0.95, then the presence of text can be confirmed as the match certainty exceeded the match certainty threshold.

In some embodiments, the statistically generated model can be a text model (e.g., IBM Watson Text Recognition). The text model can be configured to extract text from an image and calculate a match certainty for words of the extracted text. For example, if a white board including the words “Inventor Team Meeting” is captured by a front-facing camera of an HMD, then the text model can output the text classifications: inventor 0.88, team 0.90, and meeting 0.94. The extraction of text via the text model can be used to confirm that text is present. In embodiments, a threshold number of words identified by the text model can be used to indicate the presence of text. The threshold number of words can be any suitable number (e.g., 5 words, 10 words, 30 words, etc.). In some embodiments, a match certainty threshold of word classifications can be used to indicate the presence of text. For example, if a match certainty for any word classification output by the text model exceeds 0.75, the presence of text can be confirmed. In some embodiments, a combination of a threshold number of words and a match certainty threshold for each respective word can be considered to confirm the presence of text. For example, assume a lower limit threshold number of words is five, and a lower limit threshold match certainty for each word is 0.75. In this embodiment, if the words identified by the text model are: “Let's go camping tomorrow night,” with corresponding match certainties: Let's 0.92, go: 0.88, camping 0.78, tomorrow 0.80, night 0.86, then a determination can be made that the presence of text is confirmed, given that there are at least five words each attaining the minimum match certainty threshold.

After the presence of text is confirmed, a text area can be determined. This is illustrated at operation 230. In embodiments, the text area can be determined via image recognition. For example, a boundary can be identified (e.g., using a general or textual deep learning image recognition model) which dictates the edges of the text material (e.g., a page of text). The boundary can then define the text area. In some embodiments, the data obtained by the eye-tracker (e.g., the area the user is looking at operation 220) can be used to narrow the text area based on where the user is reading. For example, if there are three paragraphs displayed on a page, then the paragraph the user is looking at (e.g., based on the analysis completed at operation 220) can be defined as the text area, while excluding the other two paragraphs. This can be completed at any suitable level of granularity (e.g., down to particular sentences, paragraphs, pages, etc.).

In embodiments where the text the user is reading is in the physical world (e.g., the text is not displayed on the HMD screen), then the text area in the physical world can be mapped to a subset of pixels on the display. This can be completed by leveraging data obtained by the eye-tracker to determine which portions (e.g., pixels) of the display the user is viewing the text through. For example, by determining the direction the user is looking (e.g., the orientation of the user's eyes), a subset of the display can be identified as the text area. In some embodiments, the user can manually define the text area on the display screen. For example, the user can trace a particular subset of his or her field of view, and the text area on the display can be defined based on the user's selection.

In embodiments where the text the user is reading is displayed on the HMD, then the pixels displaying the text can be identified as the text area. The subset of pixels which define the text area on the display can be selected in any manner. For example, for a display screen of m×n pixels, where m is the number of columns and n is the number of rows, the subset of pixels defining the text area can be selected by specific rows, columns, submatrices, or individually addressable pixels within the pixel matrix.

The non-text area of the HMD display can then be filtered. This is illustrated at operation 235. The non-text portion of the display is filtered to reduce distractions while the user wearing the HMD is reading the text. In embodiments filtering can include dimming, blacking, blurring, obfuscating, or altering a color (e.g., altering pixel bit values) of the display.

In some embodiments, the non-text area in the user's field of view is blurred (e.g., cloudiness or opaqueness is applied to the non-text area of the display) such that the user can still see objects (e.g., silhouettes or outlines of objects) moving in the background, but with little detail. This can be implemented for the user's safety, such that if a potential threat (e.g., a biker) approaches the user, the user can still react. In some embodiments, the non-text areas can be completely blocked. In these embodiments, all non-text areas of the display can be set to a pixel bit value corresponding to the color black (e.g., (0, 0, 0) in the 24-bit Red Green Blue (RGB) color space). In some embodiments, alternating pixels (e.g., one out of every two pixels, one out of every four pixels, etc.) can be deactivated (e.g., altered to a black color) such that the non-text area is semi-transparent (e.g., dimmed).

In some embodiments, a gyroscope (e.g., gyroscope 125 of FIG. 1), compass, or accelerometer can be implemented in the HMD to track the text/non-text areas while the user or text move with respect to each other. The subset of pixels which define the text area can then be automatically updated based on the movement (e.g., rotation, orientation, displacement, etc.) of the user with respect to the text. For example, assume that a user viewing text through a first subset of pixels moves his or her head such that the text is now viewed through a second subset of pixels. Data obtained from a gyroscope, compass, or accelerometer can be referenced in order to update the text area such that it is now defined by the second subset of pixels, rather than the first subset of pixels. Filtering can then be updated based on the new text/non-text area. In embodiments, after the display is filtered (e.g., a non-distracted reading mode is activated), then process 200 ends.

In embodiments, after process 200 commences, a user can manually deactivate the non-distracted reading mode. The user can deactivate the non-distracted reading mode in any manner, for example, by issuing a voice command, performing a gesture (e.g., a hand motion, a series of blinks, eye movements etc.), or interacting with an actuator (switch, button, lever, etc.). In some embodiments, the non-distracted reading mode can be automatically deactivated based on sensor data. For example, the non-distracted reading mode can be deactivated based on eye-tracker data (e.g., eye tracking indicates the user is no longer reading or viewing text), camera data (e.g., text is no longer in the user's field of view), NIC data (e.g., a web browser page including an article was closed), or display data (e.g., pixels on the HMD are no longer displaying text).

Though reference is made to improving text focus in HMD's having AR capabilities, in embodiments, aspects can be applied to improve text focus in HMD's with VR capabilities. For example, an eye-tracker can be used to determine whether eye movements are indicative of a reading state (e.g., similar to operation 215 of FIG. 2). The text area can be determined by analyzing display data displayed on the VR HMD screen (e.g., via pixel bit analysis and/or image recognition). Lastly, the non-text area can then be filtered substantially the same as, or substantially similar to, operation 235 of FIG. 2.

The aforementioned operations can be completed in any order and are not limited to those described. Additionally, some, all, or none of the aforementioned operations can be completed, while still remaining within the spirit and scope of the present disclosure. For example, in some embodiments, operation 225 may not be completed, as the presence of text can automatically be concluded based on a determination that the user is reading. Further, in some embodiments, operation 220 may not be completed, as the location the user is looking may not be necessary in situations when there is only a single text artifact present.

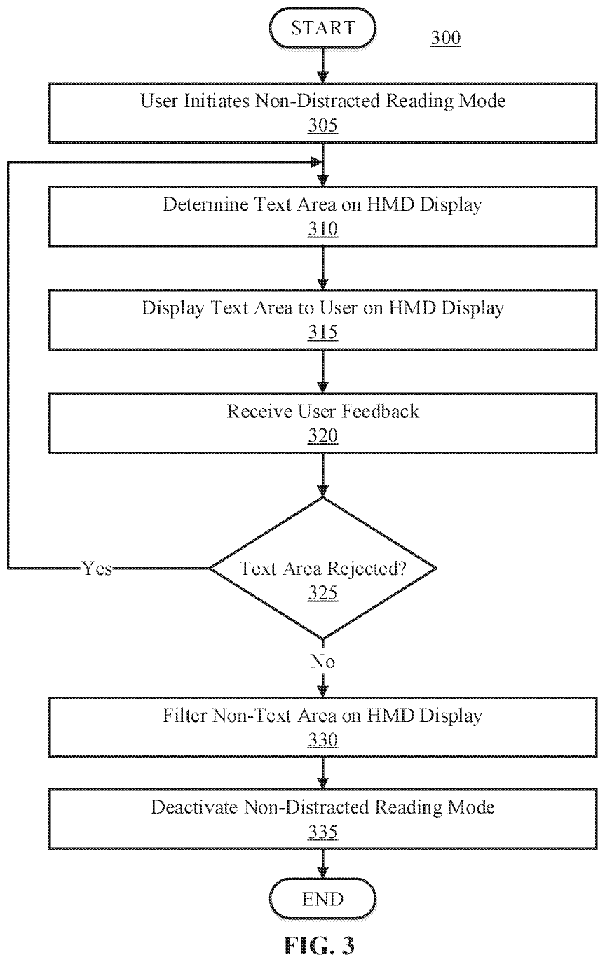

Referring now to FIG. 3, shown is a flow diagram of an example method 300 for filtering a display of an HMD, in accordance with embodiments of the present disclosure.

Method 300 starts when a user initiates a non-distracted reading mode on the HMD. This is illustrated at operation 305. The user can initiate the non-distracted reading mode in any suitable manner. For example, the user can initiate the non-distracted reading mode by issuing a voice command, making a particular gesture (e.g., a hand wave, an eye movement, a clap, etc.), or interacting with an actuator (e.g., a button, switch, lever, dial, etc.).

A text area is then determined on the HMD display. This is illustrated at operation 310. Determining the text area can be completed in a similar manner to operation 230 of FIG. 2. For example, eye-tracker data, camera data, NIC data, and/or display data can be referenced to determine a text area on the HMD display. In some embodiments, the text area can be manually defined by a user. For example, the user can make a particular hand gesture tracing the text area, which can be collected from a camera on the HMD. The hand gesture can then be analyzed, and the text area can be defined based on the pixels the hand gesture traced. As another example, the user can manually define a particular subset of pixels (e.g., a row, column, submatrix, etc.) on the HMD display. In some embodiments, the user can use a touch gesture to define the text area.

The text area is then displayed to the user on the HMD display. This is illustrated at operation 315. The text area is displayed to the user in order to verify that the determined text area is correct. This is completed because eye-tracking, image recognition, and/or manual selection can be inaccurate when selecting the text area. Further, movements by the user can alter the desired text area. As another example, the spacing between the user's eyes and the HMD display screen can vary, which can also affect the accuracy of the text area. Accordingly verifying the text area by displaying it to the user can be beneficial to improving accuracy of the identified text area. The text area can be displayed by presenting a virtual border of the text area to the user. The virtual boarder can be a line (e.g., a dashed line, solid line, etc.) tracing a particular shape (e.g., a square, rectangle, circle, etc.) on the HMD display.

User feedback regarding the displayed text area (e.g., the virtual border) is then received. This is illustrated at operation 320. The user can either accept (e.g., verify) the displayed text area as suitable (e.g., accurate), or reject (e.g., deny) the text area as inaccurate.

A determination is then made whether the displayed text area is rejected. This is illustrated at operation 325. If the text area is rejected by the user, then operation 325 returns to operation 310, when a text area is re-determined. If the text area is accepted by the user, then operation 325 proceeds to operation 330, when the non-text area on the HMD display is filtered. The non-text area on the HMD display can be filtered in the same manner, or a substantially similar manner, as operation 235 of FIG. 2.

The non-distracted reading mode is then deactivated (e.g., the filter is removed from the display of the HMD). This is illustrated at operation 335. The non-distracted reading mode can be deactivated in any suitable manner. In embodiments, the non-distracted reading mode can be manually deactivated. For example, the deactivation method can be substantially the same as the manual activation methods described in operation 305 (e.g., issuing voice commands, making gestures, or interacting with an actuator). In some embodiments, the non-distracted reading mode can be automatically deactivated based on sensor data. For example, the non-distracted reading mode can be deactivated based on eye-tracker data (e.g., eye tracking indicates the user is no longer reading or viewing text), camera data (e.g., text is no longer in the user's field of view), NIC data (e.g., a document was recently closed on another device), or display data (e.g., pixels on the HMD are no longer displaying text).

The aforementioned operations can be completed in any order and are not limited to those described. Additionally, some, all, or none of the aforementioned operations can be completed, while still remaining within the spirit and scope of the present disclosure. For example, in some embodiments, operations 315-325 may not be completed, as the non-text area on the HMD can be filtered based on the determined text area without requesting user feedback.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

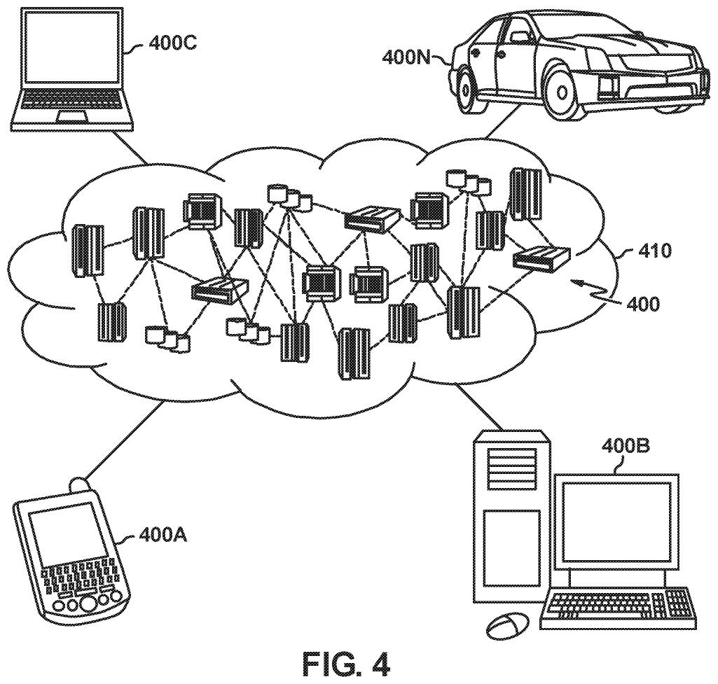

Referring now to FIG. 4, illustrative cloud computing environment 410 is depicted. As shown, cloud computing environment 410 includes one or more cloud computing nodes 400 with which local computing devices used by cloud consumers, such as, for example, personal digital assistant (PDA) (e.g., HMD 100) or cellular telephone 400A, desktop computer 400B laptop computer 400C, and/or automobile computer system 400N can communicate. Nodes 400 can communicate with one another. They can be grouped (not shown) physically or virtually, in one or more networks, such as Private, Community, Public, or Hybrid clouds as described hereinabove, or a combination thereof. This allows cloud computing environment 410 to offer infrastructure, platforms and/or software as services for which a cloud consumer does not need to maintain resources on a local computing device. It is understood that the types of computing devices 400A-N shown in FIG. 4 are intended to be illustrative only and that computing nodes 400 and cloud computing environment 410 can communicate with any type of computerized device over any type of network and/or network addressable connection (e.g., using a web browser).

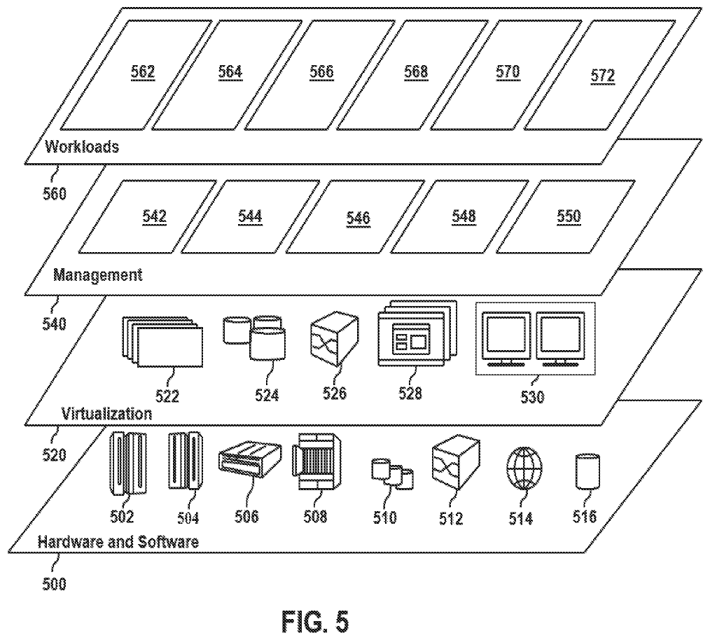

Referring now to FIG. 5, a set of functional abstraction layers provided by cloud computing environment 410 (FIG. 4) is shown. It should be understood in advance that the components, layers, and functions shown in FIG. 5 are intended to be illustrative only and embodiments of the disclosure are not limited thereto. As depicted below, the following layers and corresponding functions are provided.

Hardware and software layer 500 includes hardware and software components. Examples of hardware components include: mainframes 502; RISC (Reduced Instruction Set Computer) architecture based servers 504; servers 506; blade servers 508; storage devices 510; and networks and networking components 512. In some embodiments, software components include network application server software 514 and database software 516.

Virtualization layer 520 provides an abstraction layer from which the following examples of virtual entities can be provided: virtual servers 522; virtual storage 524; virtual networks 526, including virtual private networks; virtual applications and operating systems 528; and virtual clients 530.

In one example, management layer 540 can provide the functions described below. Resource provisioning 542 provides dynamic procurement of computing resources and other resources that are utilized to perform tasks within the cloud computing environment. Metering and Pricing 544 provide cost tracking as resources are utilized within the cloud computing environment, and billing or invoicing for consumption of these resources. In one example, these resources can include application software licenses. Security provides identity verification for cloud consumers and tasks, as well as protection for data and other resources. User portal 546 provides access to the cloud computing environment for consumers and system administrators. Service level management 548 provides cloud computing resource allocation and management such that required service levels are met. Service Level Agreement (SLA) planning and fulfillment 550 provide pre-arrangement for, and procurement of, cloud computing resources for which a future requirement is anticipated in accordance with an SLA.

Workloads layer 560 provides examples of functionality for which the cloud computing environment can be utilized. Examples of workloads and functions which can be provided from this layer include: mapping and navigation 562; software development and lifecycle management 564; virtual classroom education delivery 566; data analytics processing 568; transaction processing 570; and display filtering 572.

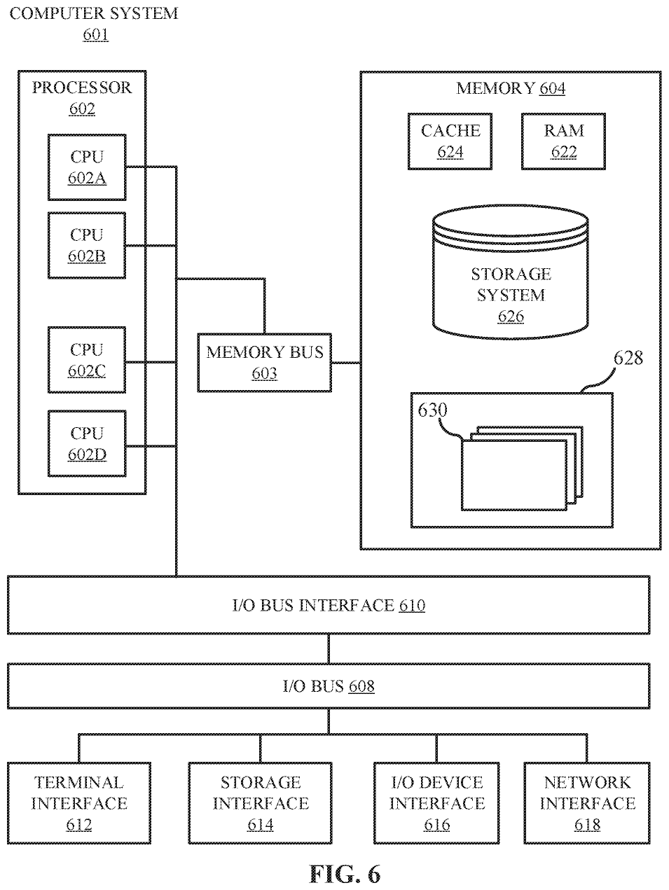

Referring now to FIG. 6, shown is a high-level block diagram of an example computer system 601 (e.g., HMD 100 of FIG. 1) that can be used in implementing one or more of the methods, tools, and modules, and any related functions, described herein (e.g., using one or more processor circuits or computer processors of the computer), in accordance with embodiments of the present disclosure. In some embodiments, the major components of the computer system 601 can comprise one or more CPUs 602, a memory subsystem 604, a terminal interface 612, a storage interface 614, an I/O (Input/Output) device interface 616, and a network interface 618, all of which can be communicatively coupled, directly or indirectly, for inter-component communication via a memory bus 603, an I/O bus 608, and an I/O bus interface unit 610.

The computer system 601 can contain one or more general-purpose programmable central processing units (CPUs) 602A, 602B, 602C, and 602D, herein generically referred to as the CPU 602. In some embodiments, the computer system 601 can contain multiple processors typical of a relatively large system; however, in other embodiments the computer system 601 can alternatively be a single CPU system. Each CPU 602 can execute instructions stored in the memory subsystem 604 and can include one or more levels of on-board cache.

System memory 604 can include computer system readable media in the form of volatile memory, such as random access memory (RAM) 622 or cache memory 624. Computer system 601 can further include other removable/non-removable, volatile/non-volatile computer system storage media. By way of example only, storage system 626 can be provided for reading from and writing to a non-removable, non-volatile magnetic media, such as a “hard-drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 604 can include flash memory, e.g., a flash memory stick drive or a flash drive. Memory devices can be connected to memory bus 603 by one or more data media interfaces. The memory 604 can include at least one program product having a set (e.g., at least one) of program modules that are configured to carry out the functions of various embodiments.

One or more programs/utilities 628, each having at least one set of program modules 630 can be stored in memory 604. The programs/utilities 628 can include a hypervisor (also referred to as a virtual machine monitor), one or more operating systems, one or more application programs, other program modules, and program data. Each of the operating systems, one or more application programs, other program modules, and program data or some combination thereof, can include an implementation of a networking environment. Programs 628 and/or program modules 630 generally perform the functions or methodologies of various embodiments.

In some embodiments, the program modules 630 of the computer system 601 can include a display filtering module. The display filtering module can be configured to determine whether a user is reading, determine where a user is looking, confirm the presence of text, determine a text area on an HMD display, and filter a non-text area on the HMD display. The aforementioned operations can be completed based on one or more user inputs and/or one or more sets of sensor data.

Although the memory bus 603 is shown in FIG. 6 as a single bus structure providing a direct communication path among the CPUs 602, the memory subsystem 604, and the I/O bus interface 610, the memory bus 603 can, in some embodiments, include multiple different buses or communication paths, which can be arranged in any of various forms, such as point-to-point links in hierarchical, star or web configurations, multiple hierarchical buses, parallel and redundant paths, or any other appropriate type of configuration. Furthermore, while the I/O bus interface 610 and the I/O bus 608 are shown as single respective units, the computer system 601 can, in some embodiments, contain multiple I/O bus interface units 610, multiple I/O buses 608, or both. Further, while multiple I/O interface units are shown, which separate the I/O bus 608 from various communications paths running to the various I/O devices, in other embodiments some or all of the I/O devices can be connected directly to one or more system I/O buses.

In some embodiments, the computer system 601 can be a multi-user mainframe computer system, a single-user system, or a server computer or similar device that has little or no direct user interface, but receives requests from other computer systems (clients). Further, in some embodiments, the computer system 601 can be implemented as a desktop computer, portable computer, laptop or notebook computer, tablet computer, pocket computer, telephone, smart phone, network switches or routers, or any other appropriate type of electronic device.

It is noted that FIG. 6 is intended to depict the representative major components of an exemplary computer system 601. In some embodiments, however, individual components can have greater or lesser complexity than as represented in FIG. 6, components other than or in addition to those shown in FIG. 6 can be present, and the number, type, and configuration of such components can vary.

As discussed in more detail herein, it is contemplated that some or all of the operations of some of the embodiments of methods described herein can be performed in alternative orders or may not be performed at all; furthermore, multiple operations can occur at the same time or as an internal part of a larger process.

The present disclosure can be a system, a method, and/or a computer program product. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But, the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A method for improving text focus for a user wearing a head mounted display (HMD), the method comprising:
determining, based on a first set of sensor data received from an eye-tracker, that the user is reading;
determining, in response to the determination that the user is reading, a text area on a display on the HMD; and
filtering the display of the HMD based on the text area, wherein a non-text area of the display is filtered and the text area is not filtered.

2. The method of claim 1, wherein determining that the user is reading includes:
obtaining, as a part of the first set of sensor data, a scanpath for the user, the scanpath indicating a set of saccades and a set of fixations for a first time interval;
calculating an average fixation duration based on the scanpath;
comparing the average fixation duration to a time range; and
determining, in response to the average fixation duration satisfying the time range, that the user is reading.

3. The method of claim 1, wherein determining a text area on the display of the HMD comprises:
receiving a text area selection;
presenting the text area selection to the display of the HMD; and
receiving an indication that the text area is suitable.

4. The method of claim 1, wherein filtering the display based on the text area of the display includes altering a color of at least a portion of pixels of the non-text area

5. The method of claim 1, wherein prior to determining the text area, a presence of text is confirmed, wherein the presence of text is confirmed by:
capturing, by a camera, an image of a field of view of the user;
determining, via text recognition, a number of words in the field of view;
comparing the number of words to a threshold; and
confirming, in response to the number of words exceeding the threshold, the presence of text in the image of the field of view of the user.

6. The method of claim 1, wherein prior to determining the text area, a location the user is looking is determined by the eye-tracker to identify a text artifact out of a plurality of text artifacts that the user is reading.

7. The method of claim 1, further comprising:
deactivating the filtering in response to an input received from the user.

8. A head mounted display (HMD) for improving text focus, the system comprising:
an eye-tracker;
a memory storing program instructions; and
a processor, wherein the processor is configured to execute the program instructions to perform a method comprising:
determining, based on a first set of sensor data received from the eye-tracker, that a user wearing the HMD is reading;
determining, in response to the determination that the user is reading, a text area on a display on the HMD; and
filtering the display of the HMD based on the text area, wherein a non-text area of the display is filtered and the text area is not filtered.

9. The HMD of claim 8, wherein determining that the user is reading includes:
obtaining, as a part of the first set of sensor data, a scanpath for the user, the scanpath indicating a set of saccades and a set of fixations for a first time interval;
calculating an average time between saccades;
comparing the average time between saccades to a time range; and
determining, in response to the average time between saccades being within the time range, that the user is reading.

10. The HMD of claim 8, further comprising a camera, wherein prior to determining the text area on the display of the HMD, a presence of text is confirmed, wherein the presence of text is confirmed by:
capturing, by the camera, an image of a field of view of the user;
determining, via image recognition, a match certainty that an object in the image is a text artifact;
comparing the match certainty to a match certainty threshold; and
confirming, in response to the match certainty exceeding the match certainty threshold, the presence of text in the image of the field of view of the user.

11. The HMD of claim 8 further comprising a network interface controller (NIC), wherein prior to determining the text area on the display of the HMD, a presence of text is confirmed, wherein the presence of text is confirmed by:
receiving, by the NIC, an indication that text is displayed on a second device communicatively coupled to the HMD via the NIC; and
confirming, in response to the indication that text is displayed on the second device, the presence of text.

12. The HMD of claim 11, wherein the indication that text is displayed on the second device is based on a file format of a file displayed on the second device.

13. The HMD of claim 8, wherein the method performed by the processor further comprises:
deactivating the filtering in response to receiving a voice command from the user.

14. The HMD of claim 8, further comprising a gyroscope, wherein the method performed by the processor further comprises:
receiving, based on a second set of sensor data received from the gyroscope, an indication that the text area of the display moved to a second location of the display;
updating the text area to the second location of the display based on the second set of sensor data.

15. A computer program product comprising a computer readable storage medium having program instructions embodied therewith, the program instructions executable by a processor to cause the processor to perform a method for improving text focus for a user wearing a head mounted display (HMD), the method comprising:
determining, based on a first set of sensor data received from an eye-tracker, that the user is reading;
determining, in response to the determination that the user is reading, a text area on a display on the HMD; and
filtering the display of the HMD based on the text area, wherein a non-text area of the display is filtered and the text area is not filtered.

16. The computer program product of claim 15, wherein determining that the user is reading includes:
obtaining, as a part of the first set of sensor data, a scanpath for the user, the scanpath indicating a set of saccades and a set of fixations for a first time interval;
calculating an average fixation duration based on the scanpath;
comparing the average fixation duration to a time range; and
determining, in response to the average fixation duration satisfying the time range, that the user is reading.

17. The computer program product of claim 15, wherein determining a text area on the display of the HMD comprises:
receiving a text area selection;
presenting the text area selection to the display of the HMD; and
receiving an indication that the text area is suitable.

18. The computer program product of claim 15, wherein filtering the display based on the text area of the display includes altering a color of at least a portion of pixels of the non-text area to black.

19. The computer program product of claim 15, wherein prior to determining the text area, a presence of text is confirmed, wherein the presence of text is confirmed by:
capturing, by a camera, an image of a field of view of the user;
determining, via text recognition, a number of words in the field of view;
comparing the number of words to a threshold; and
confirming, in response to the number of words exceeding the threshold, the presence of text in the image of the field of view of the user.

20. The computer program product of claim 15, wherein the method performed by the processor further comprises:
deactivating the filtering in response to detecting a gesture made by the user.
